(19) United States
(12) Patent Application Publication
(10) Pub. No.: US 2016/0230717 A1
(43) Pub. Date: Aug. 11, 2016

(54) COATING FOR ENGINE

(71) Applicant: Caterpillar Inc., Peoria, IL (US)

(72) Inventors: Jaswinder Singh, Dunlap, IL (US); Robert Dale Clayton, JR., Peoria, IL (US); Yong Yi, Dunlap, IL (US)

(73) Assignee: Caterpillar Inc., Peoria, IL (US)

(21) Appl. No.: 15/132,745

(22) Filed: Apr. 19, 2016

(51) Int. Cl. F02M 35/10; F01N 3/08; F02M 35/02

(52) U.S. Cl. CPC F02M 35/1038; F02M 35/0218; F01N 3/0871; F02M 35/10314; F01N 2510/10; F01N 2570/18; F01N 2570/22

(57) ABSTRACT

An engine system is provided. The engine system includes a passageway having an inner surface and an outer surface. The passageway is adapted to allow a flow of air therethrough. The engine system also includes a sensor provided in the passageway and in contact with the air. The sensor is adapted to sense a parameter of the air. The engine system further includes a hydrophobic coating having a micropatterned texture provided on at least one of the inner surface of the passageway and the sensor. The hydrophobic coating is adapted to limit deposition of at least one of a fluid and a solid thereon.

### TECHNICAL FIELD

The present disclosure relates to a coating for an engine. More particularly, the present disclosure relates to the coating for a passageway associated with the engine.

### BACKGROUND

Generally, in cold climate, water vapor present in an intake air of an engine may condense on inner surface of an intake system such as an intake line and/or an intake manifold. Due to low surface temperature, the condensate may further freeze forming an ice layer on the inner surface of the intake system. After an extended period of time, formation of the ice layer may increase. As a result, the ice layer may block the intake system and restrict flow of intake air therethrough. This may lead to reduced volume of intake air reaching one or more cylinders of the engine. As a result, an amount of unburned hydrocarbon may increase in an exhaust air. This unburned hydrocarbon may further bum in components of an aftertreatment system of the engine leading to damage to the aftertreatment system.

Also, in some situations, the water vapor may condense on components of the intake system such as a pressure sensor, a temperature sensor, and so on, The condensate may form a layer over the sensors leading to erroneous signals generated by the sensors.

Additionally, mixers employed in the aftertreatment system of the engine receive a flow of the exhaust air and a reductant for reducing a droplet size of the reductant and homogenizing a mixture of the exhaust air and the reductant. Due to continuous use, the reductant may accumulate on surfaces of the mixer and form deposits. Over a period of time, the deposit may grow in size leading to blockage. As a result, the performance of the mixer may reduce due to improper mixing of the reductant which may increase tail pipe emissions.

U.S. Patent Application Number 2015/0211398 describes a vehicle exhaust system. The system includes a mixer having an inlet that receives engine exhaust gases and an outlet to direct swirling engine exhaust gas to a downstream exhaust component. The mixer includes a plurality of internal surfaces that come into contact with the engine exhaust gases. At least one of the internal surfaces includes a coating comprised of a low-coefficient of friction material.

Currently used surface coatings may not be efficient to limit deposit formation of the reductant on surfaces of the mixer or condensation of water vapor on inner surfaces of the intake system over a period of time. In some situations, the mixer and/or the intake system may include additional thermal devices to limit deposit formation and condensation respectively. Such thermal devices may add to an overall system cost, reduce system efficiency, increase system weight, and so on. Also, in some situations, in order to limit deposit formation on surfaces of the mixer, dosing of the reductant may be reduced in conditions favorable for deposit formation, such as low system temperature, reduced engine load, and so on. However, this may increase engine emissions and prevent the engine from being emission complaint. Hence, there is a need for an improved coating for the engine to limit deposit formation and/or condensation of the water vapor.

### SUMMARY OF THE DISCLOSURE

In an aspect of the present disclosure, an engine system is provided. The engine system includes a passageway having an inner surface and an outer surface. The passageway is adapted to allow a flow of air therethrough. The engine system also includes a sensor provided in the passageway and in contact with the air. The sensor is adapted to sense a parameter of the air. The engine system further includes a hydrophobic coating having a micropatterned texture provided on at least one of the inner surface of the passageway and the sensor. The hydrophobic coating is adapted to limit deposition of at least one of a fluid and a solid thereon.

Other features and aspects of this disclosure will be apparent from the following description and the accompanying drawings.

### BRIEF DESCRIPTION OF THE DRAWINGS

FIG. 1 is a schematic diagram of an engine system, according to one embodiment of the present disclosure;

FIG. 2 is a partial cutaway view of an air intake system, according to one embodiment of the present disclosure;

FIG. 3 is a perspective view of a mixer of an exhaust aftertreatment system, according to another embodiment of the present disclosure; and

FIG. 4 is a side sectional view of an exemplary surface coating, according to one embodiment of the present disclosure.

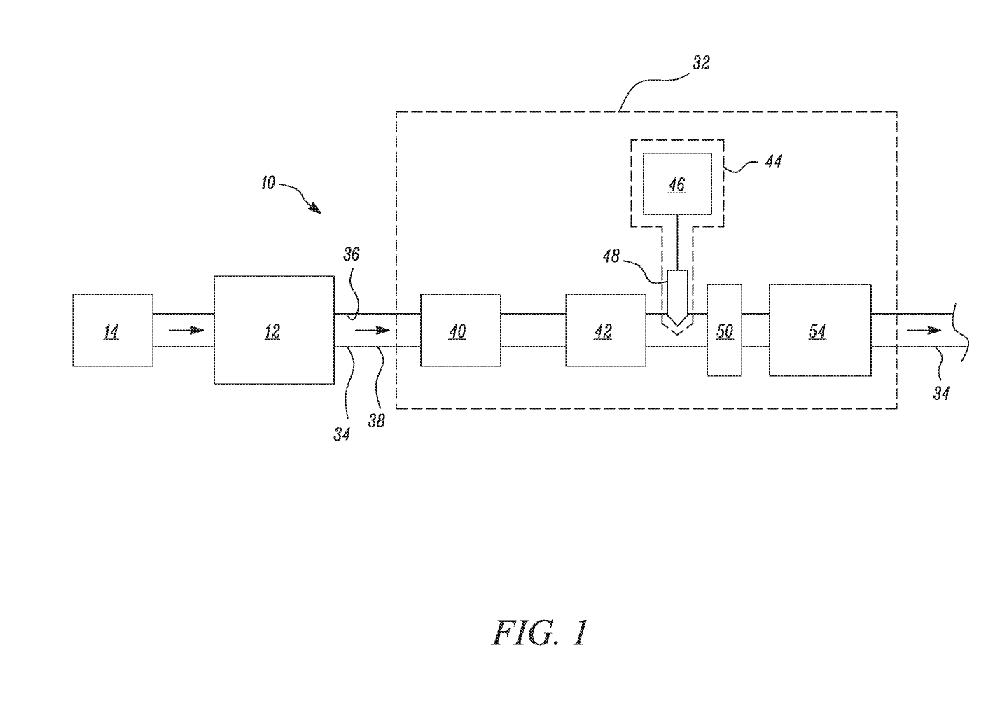

### DETAILED DESCRIPTION

Wherever possible, the same reference numbers will be used throughout the drawings to refer to the same or the like parts. Referring to FIG. 1, a schematic diagram of an engine system 10 is illustrated. The engine system 10 includes an engine 12. The engine 12 may include an internal combustion engine powered by any fuel known in the art such as gasoline, diesel, natural gas, and so on, or a combination thereof. The engine 12 may be used for applications including, but not limited to, power generation, transportation, construction, agriculture, forestry, aviation, marine, material handling, and waste management.

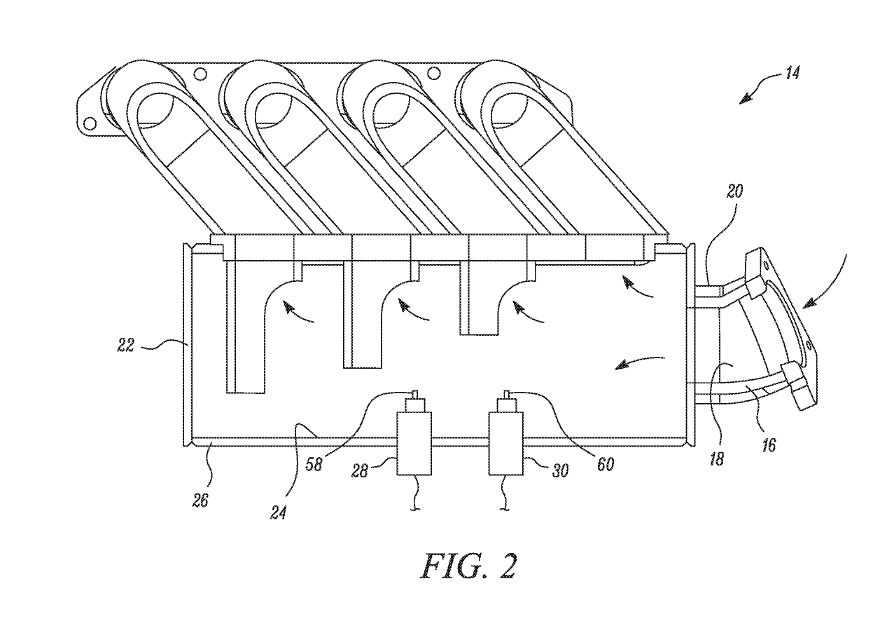

The engine system 10 includes an air intake system 14 fluidly coupled to the engine 12. The air intake system 14 is adapted to provide a flow of an intake air into the engine 12. Referring to FIG. 2, the air intake system 14 includes an intake line 16 having an inner surface 18 and an outer surface 20. The air intake system 14 also includes an intake manifold 22 having an inner surface 24 and an outer surface 26. The intake manifold 22 is fluidly coupled to the intake line 16. The intake line 16 and the intake manifold 22 are adapted to provide a passageway for the flow of the intake air from atmosphere into the engine 12. The air intake system 14 may also include an air filter (not shown) provided downstream of the intake line 16. The air filter may be adapted to provide filtration of the intake air prior to flowing into the intake line 16 and the intake manifold 22.

The air intake system 14 also includes one or more sensors such as a pressure sensor 28 and a temperature sensor 30. In other embodiments, the sensors may, additionally or alternatively, include any other sensor such as a humidity sensor, a flow rate sensor, and so on based on application requirements. The sensors are adapted to determine a parameter of the intake air. More specifically, the pressure sensor 28 is adapted to determine a pressure of the intake air. The temperature sensor 30 is adapted to determine a temperature of the intake air.

In the illustrated embodiment, the pressure sensor 28 and the temperature sensor 30 are coupled to the intake manifold 22. More specifically, the pressure sensor 28 and the temperature sensor 30 are provided in contact with the intake air. In other embodiments, the pressure sensor 28 and the temperature sensor 30 may, alternatively or additionally, be coupled to the intake line 16 based on application requirements and in contact with the intake air.

Referring to FIG. 1, the engine system 10 includes an exhaust aftertreatment system 32 fluidly coupled to the engine 12. The exhaust aftertreatment system 32 is fluidly coupled to the engine 12 via an exhaust line 34 having an inner surface 36 and an outer surface 38. The exhaust line 34 is adapted to provide a passageway for a flow of an exhaust air from the engine 12 to the exhaust aftertreatment system 32. The exhaust aftertreatment system 32 is adapted to receive and treat the exhaust air generated by the engine 12. The exhaust aftertreatment system 32 includes a Diesel Oxidation Catalyst (DOC) 40. The DOC 40 is fluidly coupled to the engine 12 via the exhaust line 34. The DOC 40 is adapted to oxidize one or more components of the exhaust air such as Carbon Monoxide (CO), Hydrocarbons (HC), and so on.

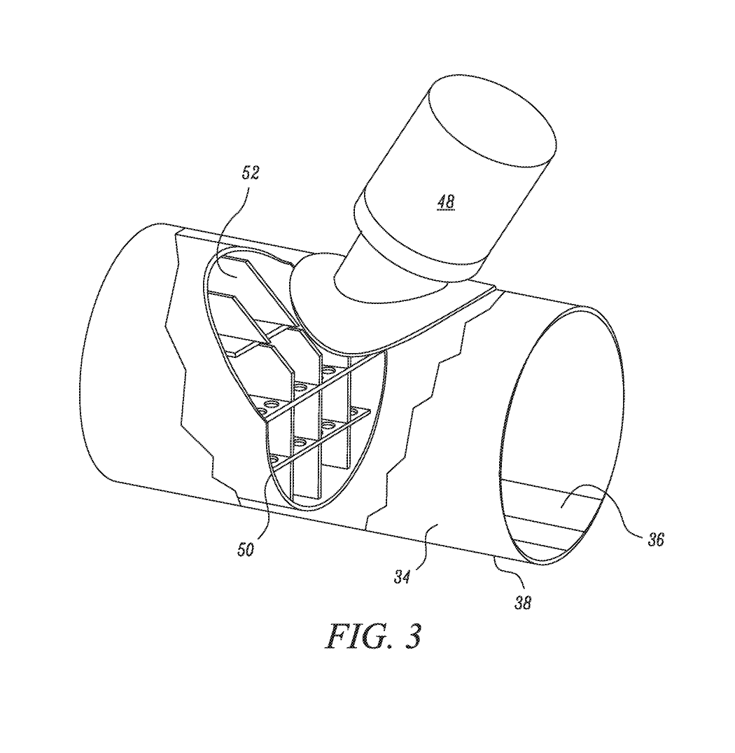

The exhaust aftertreatment system 32 includes a Diesel Particulate Filter (DPF) 42. The DPF 42 is provided downstream of the DOC 40 and fluidly coupled to the DOC 40 via the exhaust line 34. The DPF 42 is adapted to provide filtration of particulate matter present in the exhaust air, The exhaust aftertreatment system 32 includes an injection system 44. The injection system 44 includes a reductant tank 46. The reductant tank 46 is adapted to store and supply a reductant, such as a urea water solution, to the exhaust aftertreatment system 32. The injection system 44 also includes an injector 48 (also shown in FIG. 3). The injector 48 is fluidly coupled to the reductant tank 46. The injector 48 is also fluidly coupled to the exhaust line 34 downstream of the DPF 42. The injector 48 is adapted to inject the reductant from the reductant tank 46 into the exhaust line 34.

Referring to FIG. 3, the exhaust aftertreatment system 32 also includes a mixer 50 having a surface 52. The mixer 50 is provided within the exhaust line 34 and downstream of the injector 48. The mixer 50 is adapted to provide mixing and homogenizing of a mixture of the exhaust air and the reductant. The mixer 50 may be any mixer known in the art such as an impact mixer, a swirl mixer, a combination mixer, a plate type mixer, a baffle type mixer, a rotary mixer, and so on. The exhaust aftertreatment system 32 further includes a Selective Catalytic Reduction (SCR) unit 54 provided downstream of the mixer 50 and fluidly coupled to the exhaust line 34. The SCR unit 54 is adapted to reduce Nitrogen Oxides (NOx) present in the exhaust air with the reductant preferentially into Nitrogen (N₂), and water (H₂O).

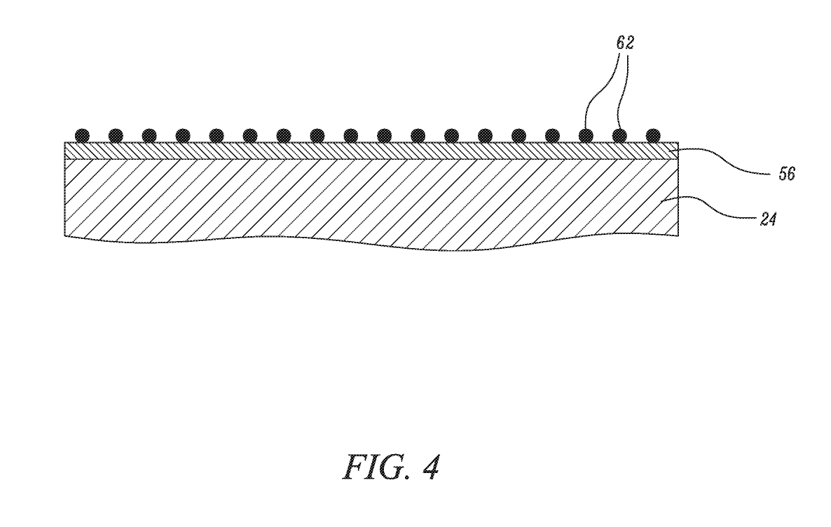

Referring to FIG. 4, the present disclosure relates to a hydrophobic coating 56 provided on at least one of an inner surface of a passageway and a sensor associated with the engine system 10. More specifically, in the illustrated embodiment, the hydrophobic coating 56 is provided on the inner surface 24 of the intake manifold 22. In other embodiments, the hydrophobic coating 56 may be provided on the inner surface 18 of the intake line 16, the surface 52 of the mixer 50, a surface 58 of the pressure sensor 28 in contact with the intake air, and/or a surface 60 of the temperature sensor 30 in contact with the intake air. in other embodiments, the hydrophobic coating 56 may, additionally or alternatively, be provided on other components of the engine system 10 and/or the exhaust aftertreatment system 32 such as a turbocharger inlet and/or outlet (not shown), a compressor inlet and/or outlet (not shown), a cylinder port (not shown), the inner surface 36 of the exhaust line 34, and so on based on application requirements and without limiting the scope of the disclosure.

Further, the hydrophobic coating 56 also includes a micropatterned texture 62 formed thereon. The hydrophobic coating 56 and the micropatterned texture 62 are adapted to limit deposition of at least one of a fluid and a solid thereon. More specifically, the hydrophobic coating 56 limits adhesion between the fluid droplets and a base surface, such as the inner surface 24 of the intake manifold 22, by increasing the contact angle between the fluid droplets and the hydrophobic coating 56. As a result, wetting of the base surface by the fluid droplets is reduced which in turn limits deposition and solidification of the fluid droplets on the base surface.

For example, when the hydrophobic coating 56 with the micropatterned texture 62 is provided on the inner surface 24 of the intake manifold 22, the inner surface 18 of the intake line 16, the surface 58 of the pressure sensor 28, and/or the surface 60 of the temperature sensor 30, the hydrophobic coating 56 is adapted to limit condensation of water vapor present in the intake air on the inner surface 24 of the intake manifold 22, the inner surface 18 of the intake line 16, the surface 58 of the pressure sensor 28, and/or the surface 60 of the temperature sensor 30 which when cooled further may form of ice. Similarly, when the hydrophobic coating 56 with the micropatterned texture 62 is provided on the surface 52 of the mixer 50, the hydrophobic coating 56 is adapted to limit deposition of reductant droplets, such as the urea water solution, and/or solid particles, such as the particulate matter, which when cooled may solidify on the surface 52 of the mixer 50.

The hydrophobic coating 56 with the micropatterned texture 62 may be made of any material having hydrophobic properties such as silica glass, grafted polymer, chrome nitride, graphene, TEFLON™ and so on. The micropatterned texture 62 may include any profile such as multiple dots, dimples, stripes, waves, peaks, valleys, crests, troughs, shapes such as triangles, circles, rectangles, and so on spaced apart from one another or a combination thereof.

Also, the hydrophobic coating 56 with the micropatterned texture 62 may be formed by any lithographic process known in the art such as chemical lithography, photolithography, and so on. In other embodiments, the hydrophobic coating 56 with the micropatterned texture 62 may be formed by any additive manufacturing process known in the art such as 3D printing and so on. In yet other embodiments, the complete component such as the intake manifold 22, the intake line 16, the pressure sensor 28, the temperature sensor 30 and/or the mixer 50 may be 3D printed with the micropatterned texture 62.

It should be noted that the hydrophobic coating 56 with the micropatterned texture 62 disclosed herein is merely exemplary. In some embodiments, the inner surface 24 of the intake manifold 22, the inner surface 18 of the intake line 16, the surface 58 of the pressure sensor 28, the surface 60 of the temperature sensor 30, and/or the surface 52 of the mixer 50 may include the micropatterned texture 62 directly on the base surface without the hydrophobic coating 56 based on application requirements. Also, a size of the micropatterned texture 62 may vary based on application requirements such that in some embodiments the micropatterned texture 62 may be fine enough to be classified as a nanopatterned texture.

### INDUSTRIAL APPLICABILITY

The present disclosure relates to the hydrophobic coating 56 with the micropatterned texture 62 provided on the surfaces of the components of the engine system 10. In cold climates, the hydrophobic coating 56 provided on the inner surfaces 18, 24 of the intake line 16 and/or the intake manifold 22 respectively limits condensation of the water vapor present in the intake air and further ice formation on the inner surfaces 18, 24. Similarly, the hydrophobic coating 56 provided on the surface 52 of the mixer 50 limits deposition and solidification of the urea droplets thereon.

The hydrophobic coating 56 provides reduction of wetting of the surface 52 of the mixer 50 by the reductant droplets. Additionally, the micropatterned texture 62 provides shearing of the reductant droplets/solid particles from the surface 52 of the mixer 50, The sheared reductant droplets/solid particles are further carried away by the flow of the exhaust air prior to accumulating into larger droplets. The micropatterned texture 62 also provides reduction of heat transfer between the surface 52 of the mixer 50 and the reductant droplets due to the increased contact angle therebetween. The reduction of heat transfer provides reduction of cold spots on the surface 52 of the mixer 50. As a result, the hydrophobic coating 56 with the micropatterned texture 62 provides reduction of accumulation of the reductant droplets and deposit formation on the mixer 50.

Similarly, the hydrophobic coating 56 provides reduction of wetting of the inner surface 24 of the intake manifold 22, the inner surface 18 of the intake line 16, the surface 58 of the pressure sensor 28, and/or the surface 60 of the temperature sensor 30 by the water droplets. Additionally, the micropatterned texture 62 provides shearing of the water droplets from the inner surface 24 of the intake manifold 22, the inner surface 18 of the intake line 16, the surface 58 of the pressure sensor 28, and/or the surface 60 of the temperature sensor 30. The sheared water droplets are further carried away by the flow of the intake air prior to accumulating into larger droplets. The micropatterned texture 62 also provides reduction of heat transfer between the inner surface 24 of the intake manifold 22, the inner surface 18 of the intake line 16, the surface 58 of the pressure sensor 28, the surface 60 of the temperature sensor 30 and the water droplets due to the increased contact angle therebetween. The reduction of heat transfer provides reduction of cold spots on the inner surface 24 of the intake manifold 22, the inner surface 18 of the intake line 16, the surface 58 of the pressure sensor 28, and/or the surface 60 of the temperature sensor 30. As a result, the hydrophobic coating 56 with the micropatterned texture 62 provides reduction of accumulation of the water droplets and ice formation on the inner surface 24 of the intake manifold 22, the inner surface 18 of the intake line 16, the surface 58 of the pressure sensor 28, and/or the surface 60 of the temperature sensor 30.

The hydrophobic coating 56 with the micropatterned texture 62 provides an effective and cost efficient method to limit ice formation within the intake system 14 and/or urea deposition on the mixer 50. The hydrophobic coating 56 with the micropatterned texture 62 may be provided on the surfaces of the components of the engine system 10 without adding considerable weight to the system and without making extensive modifications to the existing system design.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. An engine system comprising:
a passageway having an inner surface and an outer surface, the passageway adapted to allow a flow of air therethrough;
a sensor provided in the passageway and in contact with the air, the sensor adapted to sense a parameter of the and
a hydrophobic coating having a micropatterned texture provided on at least one of the inner surface of the passageway and the sensor, the hydrophobic coating adapted to limit deposition of at least one of a fluid and a solid thereon.

2. The engine system of claim 1, wherein the passageway is an intake line of an air intake system of the engine system and the air is an intake air.

3. The engine system of claim 2, wherein the fluid is water vapor in the air.

4. The engine system of claim 1, wherein the passageway is associated with a mixer of an exhaust aftertreatment system of the engine system and the air is an exhaust air.

5. The engine system of claim 4, wherein the fluid is a urea water solution.

6. The engine system of claim 4, wherein the solid is a particulate matter entrained in the exhaust air.

7. The engine system of claim 1, wherein the sensor is at least one of
a pressure sensor and the parameter is a pressure of the air; and
a temperature sensor and the parameter is a temperature of the air.
